(19) United States
(12) Patent Application Publication
(10) Pub. No.: US 2019/0219953 A1
(43) Pub. Date: Jul. 18, 2019

(54) RUBBER COMPOSITION, RUBBER ROLLER, AND IMAGE FORMING DEVICE

(71) Applicant: SUMITOMO RUBBER INDUSTRIES, LTD., Hyogo (JP)

(72) Inventors: YUSUKE TANIO, Hyogo (JP); KEISUKE OSAKA, Hyogo (JP)

(73) Assignee: SUMITOMO RUBBER INDUSTRIES, LTD., Hyogo (JP)

(21) Appl. No.: 16/149,143

(22) Filed: Oct. 2, 2018

(30) Foreign Application Priority Data
Jan. 12, 2018 (JP) 2018-003558
May 23, 2018 (JP) 2018-099002

(51) Int. Cl. G03G 15/16; C08L 9/02; C08L 71/03; C08L 9/06; C08L 9/00; C08L 23/16; C08J 9/00; C08J 9/10

(52) U.S. Cl. CPC G03G 15/162; C08J 2423/16; C08L 71/03; C08L 9/06; C08L 9/00; C08L 23/16; C08J 9/0066; C08J 9/105; C08J 9/103; C08J 9/0061; C08L 2205/035; C08L 2205/025; C08L 2203/14; C08L 2203/20; C08L 2312/02; C08J 2203/04; C08J 2201/026; C08J 2371/03; C08J 2471/03; C08J 2309/02; C08J 2409/02; C08J 2309/06; C08J 2409/06; C08J 2309/00; C08J 2409/00; C08J 2323/16; C08L 9/02

(57) ABSTRACT

A rubber composition is provided. The rubber roller including a roller body formed of a porous body formed by foaming and crosslinking the rubber composition and an image forming device including the rubber roller are also provided. In the rubber composition, fine porous particles of at least one type selected from a group consisting of zeolite, activated carbon, and diatomite along with a crosslinking component and a foaming component are mixed into a rubber that contains at least one type selected from a group consisting of diene-based rubbers and ethylene propylene-based rubbers and an ion-conductive rubber. A rubber roller includes a roller body that is formed by cylindrically extrusion-molding and crosslinking the rubber composition. An image forming device has the rubber roller 1 assembled thereinto.

### CROSS-REFERENCE TO RELATED APPLICATION

This application claims the priority benefit of Japan application serial no. 2018-003558, filed on Jan. 12, 2018, and serial no. 2018-099002, filed on May 23, 2018. The entirety of each of the above-mentioned patent applications is hereby incorporated by reference herein and made a part of this specification.

### BACKGROUND

### Technical Field

The disclosure relates to a rubber composition, a rubber roller including a roller body which is formed of a porous body formed by shaping, foaming, and crosslinking the rubber composition, and an image forming device including the rubber roller.

### Description of Related Art

For example, in an image forming device using electrophotography, such as a laser printer, an electrostatic copier, a plain-paper facsimile device, or a multifunction machine, there is a trend for requirement for an improvement in quality of a fouued image or an increase in an image forming speed with recent matureness of markets.

For example, a rubber roller including a porous and conductive roller body which is formed by cylindrically shaping, foaming, and crosslinking a rubber composition containing a rubber, a crosslinking component, and a foaming component and having electrical conductivity is used as a transfer roller which is one element of the image forming device (Japanese Laid-open No. 2013-067722, Japanese Patent Application Laid-open No. 2006-178128).

In order to satisfy the above-mentioned requirement, such a rubber roller particularly requires that an average value of cell diameters of foamed cells exposed from the outer circumferential surface of the roller body, that is, an average cell diameter, be as small as possible and unevenness in cell diameter be also small.

As described above, the roller body is generally formed by cylindrically shaping, foaming, and crosslinking a rubber composition and then polishing the outer circumferential surface thereof such that it has a predetermined outer diameter.

Accordingly, in order to decrease the average cell diameter of the foamed cells exposed from the polished outer circumferential surface or the unevenness in cell diameter, it is necessary to decrease the average cell diameter and the unevenness in cell diameter of the roller body as a whole.

However, in the related art, although it depends on the balance between viscosity and a degree of crosslinking of the rubber composition and a type or a mixing proportion of a foaming component, it is difficult to further decrease the average cell diameter of foamed cells or to further decrease the unevenness in cell diameter.

That is, even when the type, the particle size, or the mixing proportion of a foaming agent as the foaming component is adjusted, a range in which the average cell diameter of foamed cells can be decreased is limited.

As the average cell diameter decreases, foaming is further destabilized and the cell diameters of foamed cells are more likely to be uneven. For example, foamed cells with cell diameters much larger than the average cell diameter are likely to be included.

When such foamed cells with such large cell diameters are exposed from the outer circumferential surface of the roller body by polishing, there is a problem in that the quality of formed images decreases when a rubber roller including the roller body is used, for example, as a transfer roller.

In general, the roller body is installed in an image forming device such that the outer circumferential surface thereof comes into direct contact with members such as a photosensitive member or a belt.

In a transfer roller, the outer circumferential surface of the roller body also comes into direct contact with an image-forming sheet.

On the other hand, for example, the roller body may contain a component which exudes from the outer circumferential surface of the roller body, when a contact pressure is added to the roller body.

When such a component exudes from the outer circumferential surface, there is a problem in that the component transfers to a member such as a photosensitive member or a sheet coming into direct contact with the outer circumferential surface to contaminate the member or the sheet, thereby decreasing the quality of formed images.

### SUMMARY

The disclosure provides a rubber composition that can serve as the source of a porous body of a roller body or the like, decrease an average cell diameter of foamed cells, be stably foamed to decrease unevenness in cell diameter, and prevent a member or a sheet coming into contact therewith from being contaminated due to transfer of a component to form an image with good quality.

The disclosure also provides a rubber roller including a roller body formed of a porous body formed by foaming and crosslinking the rubber composition and an image forming device including the rubber roller.

The disclosure provides a rubber composition that is used to form a porous body for an image forming device using electrophotography, the rubber composition including: a rubber that contains at least one type selected from a group consisting of diene-based rubbers and ethylene propylene-based rubbers, and an ion-conductive rubber; a crosslinking component that crosslinks the rubber; a foaming component that foams the rubber; and fine porous particles of at least one type selected from a group consisting of zeolite, activated carbon, and diatomite, wherein a total mixing proportion P of the fine porous particles of the three types when a total proportion of the rubber is 100 parts by mass satisfies Expression (1):

P≤Z×35+C×20+D×35 (1)

[where Z denotes a mass ratio of zeolite, C denotes a mass ratio of activated carbon, and D denotes a mass ratio of diatomite, when a total amount of the three types of fine porous particles is defined as 1].

The disclosure provides a rubber roller including a porous roller body which is formed of the rubber composition.

The disclosure provides an image forming device including the rubber roller.

### BRIEF DESCRIPTION OF THE DRAWINGS

FIG. 1 is a perspective view illustrating an example of a rubber roller according to an embodiment of the disclosure; and

FIG. 2 is a diagram illustrating a method of measuring a roller resistance value of the rubber roller.

### DESCRIPTION OF THE EMBODIMENTS

According to the disclosure, it is possible to provide a rubber composition that can serve as the basis of a porous body of a roller body or the like, decrease an average cell diameter of foamed cells, be stably foamed to decrease unevenness in cell diameter, and prevent a member or a sheet coming into contact therewith from being contaminated due to transfer of a component to form an image with good quality.

According to the disclosure, it is possible to provide a rubber roller including a roller body formed of a porous body formed by foaming and crosslinking the rubber composition and an image forming device including the rubber roller.

<<Rubber Composition>>

As described above, the disclosure provides a rubber composition that is used to form a porous body for an image forming device using electrophotography, the rubber composition including: a rubber that contains at least one type selected from a group consisting of diene-based rubbers and ethylene propylene-based rubbers, and an ion-conductive rubber; a crosslinking component that crosslinks the rubber; a foaming component that foams the rubber; and fine porous particles of at least one type selected from a group consisting of zeolite, activated carbon, and diatomite, wherein a total mixing proportion P of the fine porous particles of the three types when a total proportion of the rubber is 100 parts by mass satisfies Expression (1):

P≤Z×35+C×20+D×35 (1)

[where Z denotes a mass ratio of zeolite, C denotes a mass ratio of activated carbon, and D denotes a mass ratio of diatomite, when a total amount of the three types of fine porous particles is defined as 1].

According to the disclosure, zeolite, activated carbon, and diatomite which are fine porous particles having a fine porous structure adsorb some of gas generated from the foaming component at the time of foaming the rubber composition and serve to relax foaming of the rubber composition.

Accordingly, for example, when a roller body of a rubber roller is formed as a porous member, an average cell diameter in the roller body as a whole can be decreased and unevenness in cell diameter can be decreased.

Accordingly, it is possible to decrease an average cell diameter of foamed cells or unevenness in cell diameter thereof, which are exposed from the outer circumferential surface of the roller body by polishing.

A component transferring to a member or a sheet coming into contact therewith and serving as the source of contamination is generated, for example, as follows. Such a component is:

generated when a rubber or the like is kneaded to manufacture the rubber composition and included in the rubber composition;

generated when the rubber composition is shaped into a porous body shape and is crosslinked; or

generated by later use of the porous body.

On the other hand, according to the disclosure, zeolite, activated carbon, and diatomite which are fine porous particles continuously adsorb components generated after the rubber composition has been manufactured on the porous structure thereof and serve to prevent the components from exuding from the surface of the porous body.

Accordingly, for example, when a roller body of a rubber roller is formed of the porous body, it is possible to prevent the components from exuding from the outer circumferential surface of the roller body and to prevent a member or a sheet coming into direct contact with the outer circumferential surface from being contaminated due to transfer of the components in an image forming device.

Examples of the component serving as the source of contamination include residues of the crosslinking component or the like.

For example, a component with a relatively small molecular weight derived from a polymer generated at the time of a crosslinking reaction or chlorine-based gas generated from the rubber at the time of crosslinking when an epichlorohydrin rubber or a chloroprene rubber is used as the rubber is one component serving as the source of contamination.

When an acid acceptor such as hydrotalcite is mixed in, the acid acceptor serves to capture chlorine in the chlorine-based gas using an anion exchange capacity.

Accordingly, it is possible to curb the chlorine-based gas from remaining in a free state in the crosslinked rubber roller or to curb the remaining chlorine-based gas from transferring to a member or a sheet coming into contact therewith to a certain extent.

However, transferring of other components caimot be curbed even when an acid acceptor is mixed in.

Particularly, when the rubber roller is used as a transfer roller and is left at rest, for example, under a higher-temperature and high-humidity environment for a predetermined time in a state in which the rubber roller is brought into pressed contact with a photosensitive member with a predetermined contact pressure, the components exude from the outer circumferential surface of the roller body and transfer to the photosensitive member or the like, thereby easily causing formed images of poor quality.

On the other hand, according to the disclosure, even when the roller body is left at rest under the above-mentioned conditions for a predetermined time, it is possible to prevent a component serving as the source of contamination from exuding from the outer circumferential surface of the roller body and transferring to the photosensitive member or the like by the function of zeolite, activated carbon, and diatomite which are mixed in as fine porous particles.

Accordingly, when a rubber roller including the roller body is used, for example, as a transfer roller, it is possible to improve formed image quality according to a synergistic effect of the above-mentioned functions.

This will become apparent from results of examples and comparative examples which will be described later.

<Fine Porous Particles>

At least one type selected from the group consisting of zeolite, activated carbon, and diatomite having an arbitrary form such as a powder form, a particulate form, or a particle-like form can be used as the fine porous particles.

(Zeolite)

Various zeolites having a function of adsorbing gas generated from the foaming component at the time of foaming of the rubber composition or a component serving as the source of contamination can be used as the zeolite.

Specifically, examples of the zeolite include various natural zeolites derived from natural products which include a hydrous alkali metal salt, an alkaline earth metal salt, and the like of crystalline aluminosilicate which is one type of clay mineral and which have a three-dimensional network structure including fine pores at a molecular level.

For example, synthetic zeolites which are synthesized using various chemicals as a starting material or artificial zeolites which are recycled from coal ash, paper sludge ash, or the like can also be used as the zeolite.

Specific examples of the zeolite include analcite, faujasite, ashcroftine, chabazite, gmelinite, levynite, erionite, thomsonite, natrolite, mordenite, gismondite, edingtonite, gonnardite, epidesmine, laumontite, desmine, heulandite, vermiculite, laubanite, bavenite, brewsterite, epistilbite, wellsite, mesolite, glauconite, zeolite P, zeolite X, zeolite Y, zeolite T, zeolite A, and zeolite L.

One or two or more types of these zeolites can be used.

(Activated Carbon)

Various activated carbons having a function of adsorbing gas generated from the foaming component at the time of foaming of a rubber composition or a component serving as the source of contamination, which are manufactured by various manufacturing methods, can be used as the activated carbon.

Examples of the method of manufacturing activated carbon include a gas activation method of activating a source material by bringing the source material into contact with activation gas such as water vapor, carbon dioxide, air, or combustion gas at a high temperature and a chemical activation method of carbonizing and activating a source material by impregnating the source material into a zinc chloride solution and heating the resultant in an inert gas flow.

Examples of a source material for manufacturing activated carbon using the gas activation method include carbides of wood, fruit shells (such as coconut shells), bamboo, and synthetic resins, coals such as brown coals, peats, bituminous coal, lignite, and coal chars, petroleum residues, and other carbides.

An example of a source material which is used to manufacture activated carbon using the chemical activation method is wood chips.

One or two or more types of these activated carbons can be used.

(Diatomite)

Various diatomites having a function of adsorbing gas generated from the foaming component at the time of foaming of the rubber composition or a component serving as the source of contamination can be used as the diatomite.

Various diatomites obtained by pulverizing diatomites which are sediments including corpses of diatoms which are unicellular algae as a major component in arbitrary particle sizes and refining the resultant if necessary can be used as such a diatomite.

One or two or more types of these diatomites can be used.

(Mixing Proportion)

The total mixing proportion P of the three types of fine porous particles of zeolite, activated carbon, and diatomite when a total proportion of the rubber is 100 parts by mass needs to satisfy Expression (1):

P≤Z×35+C×20+D×35 (1)

[where Z denotes a mass ratio of zeolite, C denotes a mass ratio of activated carbon, and D denotes a mass ratio of diatomite, when a total amount of the three types of fine porous particles is defined as 1].

For example, when the fine porous particles include only zeolite (which includes a case in which zeolites of two or more types are used together, which is the same in the following description), Z=1, C=0, and D=0 in Expression (1) are established and thus the mixing proportion P of the zeolite is limited to being equal to or less than 35 parts by mass per total 100 parts by mass of the rubber.

When the fine porous particles include only activated carbon, Z=0, C=1, and D=0 in Expression (1) are established and thus the mixing proportion P of the activated carbon is limited to being equal to or less than 20 parts by mass per total 100 parts by mass of the rubber.

When the fine porous particles include only diatomite, Z=0, C=0, and D=1 in Expression (1) are established and thus the mixing proportion P of the diatomite is limited to being equal to or less than 35 parts by mass per total 100 parts by mass of the rubber.

When the fine porous particles include zeolite, activated carbon, and diatomite in the same amounts, Z=1/3, C=1/3, and D=1/3 in Expression (1) are established and thus the mixing proportion P of the three types of fine porous particles is limited to being equal to or less than 30 parts by mass per total 100 parts by mass of the rubber.

When the total mixing proportion P of the fine porous particles is greater than the above-mentioned ranges, a roller body after being crosslinked is excessively hard and thus, for example, appropriate flexibility suitable for use as a transfer roller may not be achieved.

A viscosity of the rubber composition before being crosslinked at the time of heating and melting may increase and thus processability of the rubber composition may decrease.

On the other hand, by limiting the mixing proportion P of the fine porous particles to the above-mentioned ranges, it is possible to maintain good flexibility of the roller body and good processability of the rubber composition.

When an amount of fine porous particles is excessively small, the above-mentioned function of adsorbing some of gas generated from the foaming component at the time of foaming of the rubber composition or relaxing foaming of the rubber composition by mixing in the fine porous particles may not be satisfactorily achieved.

For example, an average cell diameter of foamed cells exposed from the outer circumferential surface of the roller body of the rubber roller may not be decreased or unevenness in cell diameter may not be decreased.

It may then not be possible to satisfactorily achieve an effect of adsorbing a component serving as the source of contamination and curbing contamination due to transfer of the component and a decrease in image quality accompanying this.

Accordingly, in one or more embodiments, the mixing proportion of the fine porous particles is equal to or greater than 1 part by mass and equal to or less than 3 parts by mass in the above-mentioned range.

Such a lower limit value is a lower limit value of the mixing proportion of the fine porous particles when only one type of zeolite, activated carbon, and diatomite is used as the fine porous particles.

The lower limit value is a lower limit value of the total mixing proportion when two or more types of fine porous particles are used together.

The reason why the upper limit value of the mixing proportion of the activated carbon is less than those of the two other types of fine porous particles is that the activated carbon serves as a reinforcing agent of the rubber and is likely to harden the roller body after being crosslinked by mixing in a smaller amount than that of the other two types.

Another reason is that the activated carbon has electron conductivity and a roller resistance value of the rubber roller after being crosslinked may become excessively less than that of a range suitable for a transfer roller when a large amount is mixed in.

Japanese Laid-open No. 2013-067722 describes zeolite as an example of a filler which may be mixed into a rubber composition.

However, in the disclosure described in Japanese Laid-open No. 2013-067722 zeolite is merely exemplified as one type of various fillers other than carbon black and an example in which zeolite is actually mixed in, and an effect thereof is verified is not included in Japanese Laid-open No. 2013-067722.

Japanese Laid-open No. 2013-067722 does not describe at all the effects specific to the disclosure that the mixed in fine porous particles such as zeolite relax foaming of a rubber composition, decreases an average cell diameter of foamed cells or unevenness in cell diameter, and adsorb a component serving as the source of contamination to prevent the component from transferring and contaminating a member or a sheet, thereby forming an image with good quality.

Japanese Laid-open No. 2006-178128 describes that a rubber composition in which a porous filler (fine porous particles) such as zeolite is mixed into a silicone rubber including a foaming agent is shaped in a cylindrical shape, foamed, and crosslinked to form a fixing roller.

The porous filler serves to adsorb a gas in a foamed body which has expanded by heating in the formed fixing roller and to curb thermal expansion with an increase in temperature of the fixing roller.

However, zeolite including crystalline aluminosilicate as a major component, activated carbon including carbon as a major component, and diatomite including silicon dioxide as a major component have higher affinity with silicone rubber than with other rubbers.

Accordingly, when fine porous particles and silicone rubber are combined, there are many pores of the fine porous particles, the silicone rubber in a molten state is adsorbed thereon, and thus gas or a component serving as the source of contamination is not satisfactorily adsorbed.

Accordingly, with the combination with silicone rubber, the effects that gas is adsorbed to decrease the average cell diameter of foamed cells or the unevenness thereof, and a component serving as the source of contamination is adsorbed to prevent a member or a sheet from being contaminated due to transfer of the component are not achieved.

This will also become apparent from examples, comparative examples, and conventional examples which will be described later.

<Rubber>

As described above, at least a diene-based rubber and/or an ethylene propylene-based rubber and an ion-conductive rubber are used together as the rubber.

Particularly, in one or more embodiments, in a state in which other rubbers such as silicone rubber are not included (are excluded), only the diene-based rubber and/or the ethylene propylene-based rubber and the ion-conductive rubber be used together as the rubber.

Among these, the diene-based rubber and/or the ethylene propylene-based rubber serves to provide good characteristics for the rubber, that is, characteristics of being flexible, a compression permanent set being small, and it being difficult for settling to occur, to the roller body.

The ion-conductive rubber serves to give appropriate ion conductivity to the roller body and to adjust a roller resistance value of the rubber roller, for example, to a range suitable for a transfer roller.

(Diene-Based Rubber)

Examples of the diene-based rubber include a natural rubber, an isoprene rubber (IR), an acrylonitrile butadiene rubber (NBR), a styrene butadiene rubber (SBR), a butadiene rubber (BR), and a chloroprene rubber (CR).

Particularly, in one or more embodiments, at least one type of the three types including NBR, SBR, and BR is used as the diene-based rubber.

NBR

All of a low-nitrile NBR of which an acrylonitrile content is equal to or less than 24%, a middle-nitrile NBR of which the acrylonitrile content ranges from 25% to 30%, a middle-high-nitrile NBR of which the acrylonitrile content ranges from 31% to 35%, a high-nitrile NBR of which the acrylonitrile content ranges from 36% to 42%, and an ultrahigh-nitrile NBR of which the acrylonitrile content is equal to or higher than 43% can be used as the NBR.

NBRs are classified into an oil extending type of which flexibility has been adjusted by adding an extender oil thereto and an oil non-extending type to which an extender oil is not added. In the disclosure, in one or more embodiments, an oil non-extending type NBR not including an extender oil serving as a bleeding material is used to prevent contamination of a photosensitive member or the like.

One or two or more types of these NBRs can be used.

SBR

Various SBRs which are synthesized by copolymerizing styrene and 1,3-butadiene using various polymerization methods such as an emulsion polymerization method and a solution polymerization method can be used as the SBR.

All of a high-styrene type SBR, a middle-styrene type SBR, and a low-styrene type SBR which are classified depending on a styrene content can be used as the SBR.

SBRs are classified into an oil extending type of which flexibility has been adjusted by adding an extender oil thereto and an oil non-extending type to which an extender oil is not added. In the disclosure, in one or more embodiments, an oil non-extending type SBR not including an extender oil serving as a bleeding material can be used to prevent contamination of a photosensitive member or the like.

One or two or more types of these SBRs can be used.

BR

Various BRs having a polybutadiene structure in a molecule and having a crosslinking ability can be used as the BR.

Particularly, in one or more embodiments, a high-cis BR of which a cis-1,4 bond content is equal to or higher than 95% and which can exhibit good characteristics for a rubber in a wide temperature range from a low temperature to a high temperature can be used.

BRs are classified into an oil extending type of which flexibility has been adjusted by adding an extender oil thereto and an oil non-extending type to which an extender oil is not added. In the disclosure, in one or more embodiments, an oil non-extending type BR not including an extender oil serving as a bleeding material can be used to prevent contamination of a photosensitive member or the like.

One or two or more types of these BRs can be used.

(Ethylene propylene-based rubber)

Examples of an ethylene propylene-based rubber include an ethylene propylene rubber (EPM) which is a copolymer of ethylene and propylene and an ethylene propylene diene rubber (EPDM) which is a copolymer of ethylene, propylene, and a diene, and in one or more embodiments, EPDM can be particularly used.

Various copolymers obtained by copolymerizing ethylene, propylene, and a diene can be used as the EPDM.

Examples of the diene include ethylidene norbornane (ENB) and dicyclopentadiene (DCPD).

EPDMs are classified into an oil extending type of which flexibility has been adjusted by adding an extender oil thereto and an oil non-extending type to which an extender oil is not added. In the disclosure, in one or more embodiments, an oil non-extending type EPDM not including an extender oil serving as a bleeding material can be used to prevent contamination of a photosensitive member or the like.

One or two or more types of these EPDMs can be used.

(Ion-Conductive Rubber)

Examples of the ion-conductive rubber include an epichlorohydrin rubber and a polyether rubber.

Among these, examples of the epichlorohydrin rubber include a homopolymer of epichlorohydrin, a binary copolymer of epichlorohydrin-ethylene oxide (ECO), a binary copolymer of epichlorohydrin-propylene oxide, a binary copolymer of epichlorohydrin-allyl glycidyl ether, a ternary copolymer of epichlorohydrin-ethylene oxide-allyl glycidyl ether (GECO), a ternary copolymer of epichlorohydrin-propylene oxide-allyl glycidyl ether, and a tetranary copolymer of epichlorohydrin-ethylene oxide-propylene oxide-allyl glycidyl ether.

Examples of the polyether rubber include a binary copolymer of ethylene oxide-allyl glycidyl ether and a ternary copolymer of ethylene oxide-propylene oxide-allyl glycidyl ether.

Among these, in one or more embodiments, copolymers including ethylene oxide, particularly, ECO and/or GECO can be used.

An ethylene oxide content in ECO and/or GECO is equal to or greater than 30 mol % in one embodiment, and particularly equal to or greater than 50 mol %, and equal to or less than 80 mol % in another embodiment.

Ethylene oxide serves to decrease the roller resistance value of the rubber roller.

However, when the ethylene oxide content is less than this range, such a function is not satisfactorily obtained and thus the roller resistance value of the rubber roller may not be satisfactorily decreased.

On the other hand, when the ethylene oxide content is greater than this range, crystallization of ethylene oxide is caused and a segmental motion of a molecular chain is hindered, whereby the roller resistance value of the rubber roller is likely to increase.

Furthermore, the roller body after being crosslinked may be excessively hardened or the viscosity of the rubber composition before being crosslinked at the time of heating and melting may increase and processability of the rubber composition may decrease.

The epichlorohydrin content in the ECO is the remainder amount after the ethylene oxide content.

That is, the epichlorohydrin content is equal to or greater than 20 mol % and equal to or less than 70 mol % in one embodiment, and particularly equal to or less than 50 mol % in another embodiment.

The allyl glycidyl ether content in the GECO is equal to or greater than 0.5 mol % in one embodiment, particularly equal to or greater than 2 mol %, and equal to or less than 10 mol % in another embodiment, and particularly equal to or less than 5 mol % in another embodiment.

The allyl glycidyl ether has a function of securing a free volume for a side chain and thus serves to curb crystallization of ethylene oxide and to decrease the roller resistance value of the rubber roller.

However, when the allyl glycidyl ether content is less than this range, such a function is not satisfactorily exhibited and thus the roller resistance value of the rubber roller may not be satisfactorily decreased.

On the other hand, the allyl glycidyl ether serves as a crosslinking point at the time of crosslinking of the GECO.

Accordingly, when the allyl glycidyl ether content is greater than this range, the crosslinking density of the GECO increases excessively to hinder the segmental motion of a molecular chain, and thus the roller resistance value of the rubber roller is likely to increase.

The epichlorohydrin content in the GECO is the remainder amount after the ethylene oxide content and the allyl glycidyl ether content.

That is, the epichlorohydrin content is equal to or greater than 10 mol % in one embodiment, particularly equal to or greater than 19.5 mol %, and equal to or less than 69.5 mol % in another embodiment, and particularly equal to or less than 60 mol % in another embodiment.

In addition to the copolymers in the narrow sense obtained by copolymerizing the above-mentioned three types of monomers, modified materials obtained by modifying an epichlorohydrin ethylene oxide copolymer (ECO) using allyl glycidyl ether is also known as the GECO.

Any of the GECOs can be used in the disclosure.

One or two or more types of these ion-conductive rubbers can be used.

(Mixing Proportion)

With respect to total 100 parts by mass of the rubber, the mixing proportion of the ion-conductive rubber is equal to or greater than 50 parts by mass in one embodiment, particularly equal to or greater than 55 parts by mass, and equal to or less than 70 parts by mass in another embodiment, and particularly equal to or less than 65 parts by mass in another embodiment.

The mixing proportion of the diene-based rubber and/or the ethylene propylene-based rubber is the remainder amount after the ion-conductive rubber.

That is, the mixing proportion of the diene-based rubber and/or the ethylene propylene-based rubber can be set such that the total content of the rubber is 100 parts by mass when the mixing proportion of the ion-conductive rubber is set to a predetermined value in the above-mentioned range.

When the mixing proportion of the ion-conductive rubber is less than this range or greater than the range, the roller resistance value of the rubber roller may not be adjusted to be, for example, in a range suitable for a transfer roller in any case.

When the mixing proportion of the ion-conductive rubber is greater than the range, the proportion of the diene-based rubber and/or the ethylene propylene-based rubber decreases relatively and desired characteristics for a rubber may not be given to the roller body.

On the other hand, by setting the mixing proportion of the ion-conductive rubber to be in the range, the roller resistance value of the rubber roller can be adjusted to, for example, the range suitable for a transfer roller.

The desired characteristics for a rubber can be given to the roller body.

(Crosslinking Component)

As the crosslinking component, a crosslinking agent for crosslinking a rubber and a crosslinking accelerator for accelerating crosslinking of a rubber using the crosslinking agent are used together.

Among these, examples of the crosslinking agent include a sulfur-based crosslinking agent, a thiourea-based crosslinking agent, a triazine derivative-based crosslinking agent, a peroxide-based crosslinking agent, and various monomers.

The crosslinking agents can be appropriately selected depending on the type of the rubber which is combined.

For example, when a rubber is a combination of a diene-based rubber and/or an EPDM with a GECO having a sulfur crosslinking ability, a sulfur-based crosslinking agent can be used as the crosslinking agent.

For example, when the ion-conductive rubber is an ECO not having a sulfur crosslinking ability, a sulfur-based crosslinking agent for crosslinking the diene-based rubber and/or the EPDM and a thiourea-based crosslinking agent for crosslinking the ECO can be used together as the crosslinking agent.

(Sulfur-Based Crosslinking Agent)

Examples of the sulfur-based crosslinking agent include sulfurs such as powdery sulfur, oil-treated powdery sulfur, precipitated sulfur, colloidal sulfur, and dispersible sulfur and sulfur-containing organic compounds such as tetramethylthiuram disulfide and N,N-dithiobismorpholine, and sulfur is particularly used in one or more embodiments.

In one or more embodiments, the mixing proportion of sulfur is equal to or greater than 0.5 parts by mass and equal to or less than 2 parts by mass with respect to total 100 parts by mass of the rubber in consideration of desired characteristics for a rubber being given to the roller body.

For example, when an oil-treated powdery sulfur or a dispersible sulfur is used as the sulfur, the mixing proportion is set to a proportion of sulfur itself as an effective component included therein.

In one or more embodiments, when a sulfur-containing organic compound is used as the crosslinking agent, the mixing ratio thereof is adjusted such that the proportion of sulfur included in a molecule with respect to total 100 parts by mass of rubbers is within the above-mentioned range.

(Crosslinking Accelerator)

Examples of the crosslinking accelerator for accelerating crosslinking of a rubber using a sulfur-based crosslinking agent include one or two or more types of a thiazole-based accelerator, a thiuram-based accelerator, a sulfonamide-based accelerator, and a dithiocarbamate-based accelerator.

Among these, in one or more embodiments, a thiuram-based accelerator and a thiazole-based accelerator are used together.

Examples of the thiuram-based accelerator include one or two or more types of tetramethylthiuram monosulfide, tetramethylthiuram disulfide, tetraethylthiuram disulfide, tetrabutylthiuram disulfide, and dipentamethylenethiuram tetrasulfide.

Examples of the thiazole-based accelerator include one or two or more types of 2-mercaptobenzothiazole, di-2-benzothiazolyl disulfide, a zinc salt of 2-mercaptorbenzothiazole, a cyclohexylamine salt of 2-mercaptorbenzothiazole, and 2-(4′-morpholinodithio)-bezothiazole. In consideration of an effect of accelerating crosslinking of a rubber using a sulfur-based crosslinking agent being sufficiently exhibited in a system in which the two types of crosslinking accelerators are used together, in one or more embodiments, the mixing proportion of the thiuram-based accelerator is equal to or greater than 0.3 parts by mass and equal to or less than 3 parts by mass with respect to total 100 parts by mass of rubbers.

In one or more embodiments, the mixing proportion of the thiazole-based accelerator is equal to or greater than 0.3 parts by mass and equal to or less than 2 parts by mass with respect to a total of 100 parts by mass of rubbers.

(Thiourea-Based Crosslinking Agent)

Various thiourea compounds which have a thiourea structure in a molecule and which can serve as a crosslinking agent for the ECO can be used as the thiourea-based crosslinking agent.

Examples of the thiourea-based crosslinking agent include one or two or more types from ethylene thiourea, N,N′-diphenyl thiourea, trimethyl thiourea, and thiourea which are represented by Expression (2), and in one or more embodiments, tetramethylthiourea, and ethylene thiourea are particularly used.

(CₙH₂ₙ₊₁NH)₂C═S (2)

[where n is an integer from 1 to 12.]

In consideration of desired characteristics for a rubber being given to the roller body, in one or more embodiments, the mixing proportion of a thiourea-based crosslinking agent is equal to or greater than 0.3 parts by mass and equal to or less than 1 part by mass with respect to total 100 parts by mass of rubbers.

(Crosslinking Accelerator)

Along with the thiourea-based crosslinking agent, various crosslinking accelerators for accelerating a crosslinking reaction of the ECO using the thiourea-based crosslinking agent may be used together.

Examples of the crosslinking accelerator include guanidine-based accelerators such as 1,3-diphenylguanidine, 1,3-di-o-tolylguanidine, and 1-o-tolylbiguanide, and in one or more embodiments 1,3-diphenylguanidine can be particularly used.

In consideration of an effect of accelerating a crosslinking reaction being sufficiently exhibited, in one or more embodiments, the mixing proportion of the crosslinking accelerator is equal to or greater than 0.3 parts by mass and equal to or less than 1 part by mass with respect to total 100 parts by mass of rubbers.

<Foaming Component>

Various foaming agents that are decomposed by heating to generate a gas can be used as the foaming component. A foaming assistant that serves to decrease a decomposition temperature of a foaming agent and to accelerate the decomposition may be combined therewith.

(Foaming Agent)

Examples of the foaming agent include one or two or more types from azodicarbonamide (ADCA), 4,4′-oxybis(benzene sulfonyl hydrazide) (OBSH), and N,N-dinitroso pentamethylene tetramine (DPT).

In one or more embodiments, the mixing proportion of the foaming agent is equal to or greater than 1 part by mass and equal to or less than 5 parts by mass with respect to total 100 parts by mass of rubbers.

(Foaming Assistant)

Various foaming assistants that serve to decrease a decomposition temperature of the foaming agent which is combined and to accelerate the decomposition thereof can be used as the foaming assistant and, for example, a urea(H₂NCONH₂)-based foaming assistant can be used as a foaming assistant which is combined with the ADCA.

The mixing proportion of the foaming assistant can be arbitrarily set depending on the type of the foaming agent which is combined, but is equal to or greater than 1 part by mass and equal to or less than 5 parts by mass with respect to total 100 parts by mass of rubbers in one or more embodiments.

(Foaming Component)

As the foaming component, in one or more embodiments, the ADCA and a urea-based foaming assistant be combined or the OBSH be used alone.

<Others>

Various additives may be mixed into the rubber composition if necessary.

Examples of the additives include an acid acceptor and a filler.

Among these, the acid acceptor serves to capture chlorine in chlorine-based gas generated from the epichlorohydrin rubber or the like at the time of crosslinking and to prevent the chlorine-based gas from remaining in a free state in the rubber roller or causing hindering of crosslinking or contamination of a photosensitive member.

Various materials serving as acid receptors can be used as the acid acceptor, but in one embodiment, hydrotalcite or magnesite among them can be used, and in another embodiment, hydrotalcite can be particularly used.

When hydrotalcite is used along with magnesium oxide or potassium oxide, it is possible to achieve a better acid receiving effect and to satisfactorily prevent contamination of a photosensitive member or the like.

With respect to total 100 parts by mass of rubbers, the mixing proportion of the acid acceptor is equal to or greater than 0.2 parts by mass in one embodiment, particularly equal to or greater than 0.5 parts by mass, and equal to or less than 5 parts by mass in another embodiment, and particularly equal to or less than 2 parts by mass in another embodiment.

Examples of the filler include one or two or more types of zinc oxide, silica, carbon black, talc, calcium carbonate, magnesium carbonate, and aluminum hydroxide.

A mechanical strength of the rubber roller or the like can be improved by mixing the filler.

By using conductive carbon black as the filler, electron conductivity may be given to the rubber roller.

In one or more embodiments, HAF can be used as the conductive carbon black. The HAF can be uniformly dispersed in the rubber composition and thus can give as uniform electron conductivity as possible to the rubber roller.

In one or more embodiments, the mixing proportion of the conductive carbon black is equal to or greater than 5 parts by mass and equal to or less than 20 parts by mass with respect to total 100 parts by mass of rubbers.

As the additives, various additives such as a crosslinking assistant, a deterioration inhibitor, an antiscorching agent, a plasticizer, a lubricant, an antistatic agent, a flame retardant, a neutralizer, a nucleating agent, and a co-crosslinking agent may be mixed at arbitrary proportions.

<<Rubber Roller>>

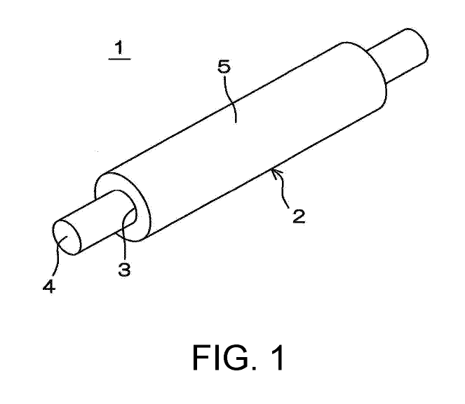

FIG. 1 is a perspective view illustrating an example of a rubber roller according to an embodiment of the disclosure.

Referring to FIG. 1, the rubber roller 1 of this example includes a porous roller body 2 which is formed in a single-layer cylindrical shape out of a foamed body of the rubber composition including the above-mentioned components, and a shaft 4 is inserted into and fixed to a penetration hole 3 at the center of the roller body 2.

The shaft 4 is integrally formed of materials having good conductivity, for example, metals such as iron, aluminum, an aluminum alloy, and stainless steel.

For example, the shaft 4 is electrically connected to the roller body 2 via an adhesive having conductivity and is mechanically fixed thereto, or is electrically connected to the roller body 2 and is mechanically fixed thereto by pressing and fitting the shaft having an outer diameter larger than an inner diameter of the penetration hole 3 into the penetration hole 3.

The shaft 4 may be electrically connected to the roller body 2 and be mechanically fixed thereto using the two methods together.

<Roller Resistance Value>

A roller resistance value R (Ω) of the rubber roller 1 can be set to a range suitable for an application of the rubber roller depending on the application.

For example, in one or more embodiments, in the case of a transfer roller, the roller resistance value R (Ω) measured using the following measuring method is equal to or greater than 6.5 and equal to or less than 7.5 in terms of a common logarithm value logR under a room-temperature and normal-humidity environment of a temperature of 23±1° C. and relative humidity of 55±1%.

(Measurement of Roller Resistance Value)

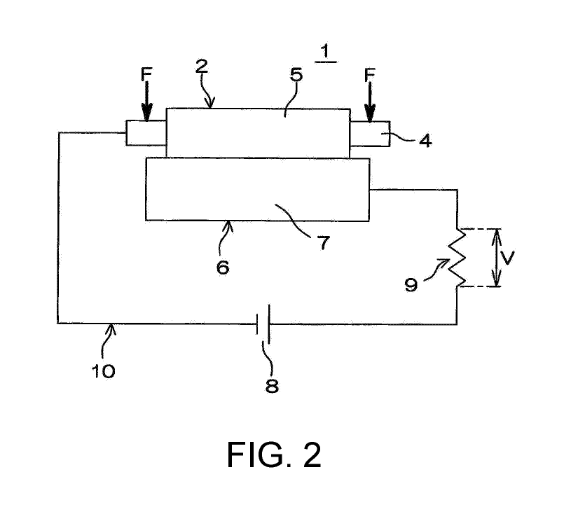

FIG. 2 is a diagram illustrating a method of measuring a roller resistance value of a rubber roller.

Referring to FIGS. 1 and 2, in this measuring method, an aluminum drum 6 that can rotate at a constant rotation speed is prepared, and an outer circumferential surface 5 of the roller body 2 of the rubber roller 1 of which the roller resistance value is to be measured is brought into contact with an outer circumferential surface 7 of the prepared aluminum drum 6 from above.

A DC power supply 8 and a resistor 9 are connected in series between the shaft 4 of the rubber roller 1 and the aluminum drum 6 to constitute a measurement circuit 10.

The (−) side of the DC power supply 8 is connected to the shaft 4 and the (+) side thereof is connected to the resistor 9.

A resistance valuer of the resistor 9 is set to 100 Ω. Subsequently, in a state in which a load F of 4.9 N (≈500 gf) is applied to both ends of the shaft 4 to bring the roller body 2 into press contact with the aluminum drum 6, the aluminum drum 6 is rotated at 30 rpm.

While maintaining rotation, an application voltage E of DC 1000 V is applied between the rubber roller 1 and the aluminum drum 6 from the DC power supply 8 and a detection voltage V applied across the resistor 9 is measured after 30 seconds has elapsed.

The roller resistance value R of the rubber roller 1 is basically calculated by Expression (i′) from the measured detection voltage V and the application voltage E (=1000 V).

R=rxE/V−r (i′)

Since the term −r in Expression (i′) can be considered as being very small, a value calculated by Expression (i) is defined as the roller resistance value of the rubber roller 1.

R=rxE/V (i)

<Asker C Hardness>

In one or more embodiments, in the case of a transfer roller, the rubber hardness of the roller body 2 is equal to or greater than 20° and equal to or less than 45° in terms of Asker C hardness.

When the Asker C hardness is less than the range, strength of the roller body 2 is insufficient and settling or the like may be likely to be caused.

On the other hand, when the Asker C hardness is greater than the range, the roller body 2 is excessively hardened and thus appropriate flexibility suitable for use as a transfer roller may not be obtained.

The Asker C hardness of the roller body 2 is expressed as a value measured under a room-temperature and normal-humidity environment of a temperature of 23±1° C. and relative humidity of 55±1% by the following method using a type C hardness tester (for example, Asker rubber hardness meter Type C made by Kobunshi Keiki Co, Ltd) based on the Standard SRIS0101 of the Society of Rubber Industry, Japan, “Physical Test Method of Expanded Rubber” which is referred to in Annex 2 of the Japanese Industry Standard JIS K7312-₁₉₉₆ “Physical Test Method of Thermosetting Polyurethane Elastomer Molded Product.”

(Measurement of Asker C Hardness)

In a state in which both ends of the shaft 4 inserted into and fixed to the roller body 2 are fixed to a support, a pressing needle of the Type C hardness tester is pressed against the central portion of the roller body 2, a load of 4.9 N (≈500 gf) is additionally applied thereto, and then the Asker C hardness is measured.

<Manufacturing of Rubber Roller>

When the rubber roller 1 according to the disclosure is manufactured, a rubber composition including the above-mentioned components is extrusion-molded in a cylindrical shape using an extrusion molding machine, is cut in a predetermined length, and is pressurized and heated using pressurized steam in a vulcanizer, whereby the rubber composition is foamed and crosslinked.

The foamed and crosslinked cylindrical product is heated for second crosslinking using an oven or the like, is then cooled, and is polished to have a predetermined outer diameter, thereby forming the roller body 2.

The shaft 4 can be inserted into and fixed to the penetration hole 3 at an arbitrary time point from cutting of the cylindrical product to polishing thereof.

Here, after being cut, in one or more embodiments, second crosslinking and polishing be performed in a state in which the shaft 4 is inserted into the penetration hole 3.

Accordingly, it is possible to curb warpage and deformation due to expansion and contraction at the time of second crosslinking.

By performing polishing while rotating about the shaft 4, it is possible to improve workability of the polishing and to curb unevenness of the outer circumferential surface 5.

As described above, the shaft 4 can be inserted into the penetration hole 3 of the cylindrical product before being second crosslinked via a conductive adhesive, particularly, a conductive thermosetting adhesive, and then second crosslinking can be performed. Alternatively, the shaft having a larger outer diameter than the inner diameter of the penetration hole 3 can be pressed and fitted into the penetration hole 3.

In the former, by heating in an oven, the cylindrical product is subjected to second crosslinking and the thermosetting adhesive is cured and the shaft 4 is electrically connected to the roller body 2 and is mechanically fixed thereto.

In the latter, electrical connection and mechanical fixation are completed at the same time as the pressing and fitting.

As described above, the shaft 4 may be electrically connected to the roller body 2 and be mechanically fixed thereto using the two methods together.

<Cell Diameters of Foamed Cells>

In order to improve the quality of a formed image when the rubber roller 1 according to the disclosure which is manufactured through the above-mentioned processes is used, for example, for a transfer roller, an average cell diameter of foamed cells exposed from the outer circumferential surface 5 of the roller body 2 by polishing is equal to or less than 120 pm in one or more embodiments.

In one or more embodiments, unevenness in cell diameter of the foamed cells exposed from the outer circumferential surface 5 of the roller body 2 be small and the largest cell diameter be equal to or less than 150 μm.

The cell diameters are expressed as values calculated using the following method in the disclosure.

(Measurement of Cell Diameters)

When the outer circumferential surface 5 of the roller body 2 is observed at 200 magnifications using a microscope, a maximum value of the cell diameters of the foamed cells calculated from a length (μm) and a breadth (μm) of each of 30 largest foamed cells which are included in the field of view using Expression (3) is set as a largest cell diameter.

Cell diameter (μm)=(length+breadth)/2 (3)

An average value of 30 cell diameters is defined as an average cell diameter.

As described above, the rubber roller 1 according to the disclosure can be suitably used as a transfer roller n an image forming device using electrophotography, such as a laser printer, an electrostatic copier, a plain-paper facsimile device, or a multifunction machine.

The rubber roller 1 according to the disclosure can also be used, for example, a charging roller, a development roller, and a cleaning roller.

<<Image Forming Device>>

An image forming device according to the disclosure has the rubber roller 1 according to the disclosure assembled thereinto.

As described above, examples of the image forming device according to the disclosure include various image forming devices using electrophotography, such as a laser printer, an electrostatic copier, a plain-paper facsimile device, and a multifunction machine.

### EXAMPLES

The disclosure will be additionally described below with reference to examples, comparative examples, and conventional examples, but the configuration of the disclosure is not limited to the examples and the comparative examples.

<Example 1>

(Rubber Composition)

As rubbers, 50 parts by mass of GECO [HYDRIN (registered trademark) T3108 made by Zeon Corporation] and 50 parts by mass of NBR [JSR (registered trademark) N250SL made by JSR Corporation, low-nitrile NBR, acrylonitrile content: 20%, oil non-extending] were mixed.

While masticating total 100 parts by mass of both rubbers using a Banbury mixer, components other than a crosslinking component among components described in Table 1 were added thereto, the resultant was kneaded, the crosslinking component was further added thereto, and the resultant was kneaded to prepare a rubber composition.

TABLE 1

| Component | Parts by mass |
|---|---|
| Zeolite | 5.0 |
| Foaming agent | 4.0 |
| Filler | 10.0 |
| Acid acceptor | 1.5 |
| Crosslinking agent | 1.6 |
| Crosslinking accelerator DM | 1.6 |
| Crosslinking accelerator TS | 2.0 |

The components in Table 1 are as follows. Parts by mass in Table 1 is parts by mass with respect to total 100 parts by mass of rubbers.

Zeolite: natural zeolite [SP#2300 made by Nitto Funka Kogyo K.K.]

Foaming agent: OBSH [NEOCELLBORN (registered trademark) N#1000SW made by Eiwa Chemical Co., Ltd.]

Filler: carbon black HAF [product name SEAST 3 made by Tokai Carbon Co., Ltd]

Acid acceptor: hydrotalcites (DHT-4A-2 made by Kyowa Chemical Industry Co., Ltd.)

Crosslinking agent: powdery sulfur [made by Tsurumi Chemical Industry Co., ltd.]

Crosslinking accelerator DM: di-2-benzothiazolyl sulfide [product name SUNSINE MBTS made by Shandong Shanxan Chemical Co., Ltd.]

Crosslinking accelerator TS: tetramethylthiuram disulfide [SANCELER (registered trademark) TS made by Shanxian Chemical Industry Co., Ltd.]

(Rubber Roller)

The prepared rubber composition was supplied to an extrusion molding machine, was extrusion-molded in a cylindrical shape with an outer diameter of ϕ10 mm and an inner diameter of ϕ3.0 mm, and then was cut with a predetermined length, and the resultant was mounted in a temporary shaft for crosslinking with an outer diameter of ϕ2.2 mm.

Subsequently, by pressurizing and heating the cylindrical product in a vulcanizer using pressurized steam for 120° C.×10 minutes and then for 160° C.×20 minutes, the cylindrical product was foamed using gas generated by decomposition of the foaming agent and the rubber was crosslinked.

Then, the cylindrical product was mounted again in the shaft 4 with an outer diameter of ϕ5 mm having a conductive thermosetting adhesive applied to the outer circumferential surface thereof, the cylindrical product was subjected to second crosslinking and the thermosetting adhesive was cured by heating the resultant in an oven for 160° C.×60 minutes, whereby the cylindrical product was electrically connected to the shaft 4 and was mechanically fixed thereto.

Then, both ends of the cylindrical product were shaped, and the cylindrical product was finished with an outer diameter of ϕ12.5 mm (with tolerance of ±0.1 mm) to form a roller body 2 by performing traverse grinding on the outer circumferential surface 5 thereof using a cylindrical grinding machine, whereby a rubber roller 1 was manufactured.

<Example 2>

In the same way as in Example 1 except that the same amount of SBR [SUMITOMO SBR1502 made by Sumitomo Chemical Co., Ltd., styrene content: 23.5%, oil non-extending] was mixed instead of the NBR, a rubber composition was prepared and a rubber roller 1 was manufactured.

<Example 3>

In the same way as in Example 1 except that the same amount of BR [JSR BR01 made by JSR Corporation, high-cis BR, cis-1,4 bond content: 95%, oil non-extending] was mixed instead of the NBR, a rubber composition was prepared and a rubber roller 1 was manufactured.

<Example 4>

In the same way as in Example 1 except that the same amount of EPDM [ESPRENE EPDM505A made by Sumitomo Chemical Co., Ltd., ethylene content: 50%, diene content: 9.5%, oil non-extending] was mixed instead of the NBR, a rubber composition was prepared and a rubber roller 1 was manufactured.

<Comparative Examples 1 to 4>

In the same way as in Examples 1 to 4 except that zeolite was not mixed, rubber compositions were prepared and rubber rollers 1 were manufactured.

<Conventional Example 1>

5.0 parts by mass of zeolite, 2 parts by mass of organohydrogenpolysiloxane as a crosslinking agent, 5 parts by mass of dimethyl-1,1-azobis(1-cyclohexane carboxylate) as a foaming agent, and chloroplatinic acid as a catalyst were added to 100 parts by mass of a silicone rubber compound [KE-551U made by Shin-Etsu Chemical Co., Ltd.] to prepared a rubber composition.

In the same way as in Example 1 except that such a rubber composition was used, a rubber roller was manufactured.

Conventional Example 1 corresponds to reproduction of Example 1 in Japanese Laid-open No. 2006-178128.

<Measurement and Evaluation of Cell Diameters of Foamed Cells>

The average cell diameters and the largest cell diameters of foamed cells exposed from the outer circumferential surfaces 5 of the rubber rollers 1 which were manufactured in the examples, the comparative examples, and the convention example were calculated using the above-mentioned method.

A rubber roller in which the average cell diameter was equal to or less than 120 μm and the largest cell diameter was equal to or less than 150 μm was evaluated as being good (O), and a rubber roller in which the average cell diameter was equal to or less than 120 μm and the largest cell diameter was greater than 150 μm and a rubber roller in which the average cell diameter was greater than 120 μm were evaluated as being defective (X).

<Evaluation of Contamination>

(Test 1)

The roller bodies 2 of the rubber rollers 1 which were manufactured in the examples, the comparative examples, and the convention example were left at rest under a high-temperature and high-humidity environment with a temperature of 40° C. and relative humidity of 90% in a state in which the roller bodies were pressed against a photosensitive member taken out of a cartridge of a laser printer [HP LaserJet (registered trademark) P1606 do made by HP Development Company, L.P.].

A pressing load was 4.9 N (≈500 gf) for each end of the shaft 4, and was 9.8 N (≈1 kgf) for both ends.

Then, after one week has elapsed, the photosensitive member released from the pressing was assembled into the cartridge again and was set in the laser printer, ten black solid images were continuously formed, and then image defects were checked.

(Test 2)

The roller bodies 2 of the rubber rollers 1 which were manufactured in the examples, the comparative examples, and the convention example were left at rest under a high-temperature and high-humidity environment with a temperature of 40° C. and relative humidity of 90% in a state in which the roller bodies were pressed against a surface of an aluminum foil.

A pressing load was 4.9 N (≈500 gf) for each end of the shaft 4, and was 9.8 N (≈1 kgf) for both ends.

Then, after one week has elapsed, the surface of the aluminum foil released from the pressing was observed using a microscope and pressed marks were checked.

(Evaluation)

A rubber roller in which no image defect was observed in ten images formed in Test 1 and no pressed mark was observed in Test 2 was evaluated as being good without contamination (O).

On the other hand, a rubber roller in which an image defect was observed in any one of ten images formed in Test 1 and/or a pressed mark was observed in Test 2 was evaluated as being defective with contamination (X).

<Evaluation of Rubber Hardness>

The Asker C hardness of the roller bodies 2 of the rubber rollers 1 which were manufactured in the examples, the comparative examples, and the convention example under a room-temperature and nonnal-humidity environment with a temperature of 23° C. and relative humidity of 55% was measured using the above-mentioned measuring method.

A rubber roller in which the Asker C hardness was equal to or greater than 20° and equal to or less than 45° was evaluated as being good (O) and a rubber roller in which the Asker C hardness was less than 20° or greater than 45° was evaluated as being defective (X).

<Evaluation of Roller Resistance Value>

The roller resistance values R (Ω) of the rubber rollers 1 which were manufactured in the examples, the comparative examples, and the convention example under a room-temperature and normal-humidity environment with a temperature of 23° C. and relative humidity of 55% were measured using the above-mentioned measuring method.

A rubber roller in which the measured roller resistance values R (Ω) was equal to or greater than 6.5 and equal to or less than 7.5 in terms of a common logarithm value logR was evaluated as being good (O) and a rubber roller in which the measured roller resistance values R (Ω) was less than 6.5 or greater than 7.5 was evaluated as being defective (X).

These results are described in Tables 2 and 3.

TABLE 2

| | | | Exam- | | Exam- |
|---|---|---|---|---|---|
| | | Example 1 | ple 2 | Example 3 | ple 4 |
| Parts by | NBR | 50 | — | — | — |
| mass | SBR | — | 50 | — | — |
| | BR | — | — | 50 | — |
| | EPDM | — | — | — | 50 |
| | GECO | 50 | 50 | 50 | 50 |
| | Silicone rubber | — | — | — | — |
| | Zeolite | 5.0 | 5.0 | 5.0 | 5.0 |
| Evaluation | Cell diameter | ◯ | ◯ | ◯ | ◯ |
| | Contamination | ◯ | ◯ | ◯ | ◯ |
| | Asker C hardness | ◯ | ◯ | ◯ | ◯ |
| | Roller resistance | ◯ | ◯ | ◯ | ◯ |
| | value | | | | |

TABLE 3

| | | | | | | Conven- |
|---|---|---|---|---|---|---|
| | | Com. | Com. | Com. | Com. | tional |
| | | Ex. 1 | Ex. 2 | Ex. 3 | Ex. 4 | Ex. 1 |
| Parts by | NBR | 50 | — | — | — | — |
| mass | SBR | — | 50 | — | — | — |
| | BR | — | — | 50 | — | — |
| | EPDM | — | — | — | 50 | — |
| | GECO | 50 | 50 | 50 | 50 | — |
| | Silicone rubber | — | — | — | — | 100 |
| | Zeolite | — | — | — | — | 5.0 |
| Evaluation | Cell diameter | X | X | X | X | X |
| | Contamination | X | X | X | X | X |
| | Asker C hardness | ◯ | ◯ | ◯ | ◯ | ◯ |
| | Roller resistance | ◯ | ◯ | ◯ | ◯ | ◯ |
| | value | | | | | |

From the results of Examples 1 to 4 and Comparative Examples 1 to 4 in Tables 2 and 3, it can be understood that since foaming of the rubber composition can be relaxed, the average cell diameter of foamed cells can be decreased or the unevenness in cell diameter can be decreased, components serving as the source of contamination can be adsorbed, and a member or a sheet can be prevented from being contaminated due to transfer of the components by forming a roller body using the rubber composition in which fine porous particles such as zeolite are mixed, a rubber roller that can form an image with good image quality is obtained when the rubber roller is used as a transfer roller or the like.

From the results of Examples 1 to 4 and Conventional Example 1, it can be understood that when a rubber is a silicone rubber, the above-mentioned effects cannot be obtained in spite of mixing zeolite and it is not possible to decrease the average cell diameter of foamed cells exposed from the outer circumferential surface of the roller body or unevenness in cell diameter or to prevent contamination.

<Example 5>

(Rubber Composition)

As rubbers, 10 parts by mass of NBR [JSR (registered trademark) N250SL made by JSR Corporation, low-nitrile NBR, acrylonitrile content: 20%, oil non-extending], 10 parts by mass of SBR [SUMITOMO SBR1502 made by Sumitomo Chemical Co., Ltd., styrene content: 23.5%, oil non-extending], 10 parts by mass of BR [JSR BRO1 made by JSR Corporation, high-cis BR, cis-1,4 bond content: 95%, oil non-extending], 10 parts by mass of EPDM [ESPRENE EPDM 505A made by Sumitomo Chemical Co., Ltd., ethylene content: 50%, diene content: 9.5%, oil non-extending], and 60 parts by mass of GECO [HYDRIN (registered trademark) T3108 made by Zeon Corporation] were mixed.

While masticating total 100 parts by mass of the rubbers using a Banbury mixer, components other than a crosslinking component among components described in Table 4 were added thereto, the resultant was kneaded, the crosslinking component was further added thereto, and the resultant was kneaded to prepare a rubber composition.

TABLE 4

| Component | Parts by mass |
|---|---|
| Zeolite | 15.0 |
| Foaming agent | 4.0 |
| Foaming assistant | 4.0 |
| Acid acceptor | 1.5 |
| Crosslinking agent | 1.6 |
| Crosslinking accelerator DM | 1.6 |
| Crosslinking accelerator TS | 2.0 |

The components in Table 4 are as follows. Parts by mass in Table 4 is parts by mass with respect to total 100 parts by mass of rubbers.

Zeolite: natural zeolite [SP#2300 made by Nitto Funka Kogyo K.K.]

Foaming agent: ADCA [product name VINYFOR AC#3 made by Eiwa Chemical Co., Ltd.]

Foaming assistant: urea-based foaming agent [product name CELLPASTE 101 made by Eiwa Chemical Co., Ltd.]

Acid acceptor: hydrotalcites (DHT-4A-2 made by Kyowa Chemical Industry Co., Ltd.)

Crosslinking agent: powdery sulfur [made by Tsurumi Chemical Industry Co., ltd.]

Crosslinking accelerator DM: di-2-benzothiazolyl sulfide [product name SUNSINE MBTS made by Shandong Shanxan Chemical Co., Ltd.]

Crosslinking accelerator TS: tetramethylthiuram disulfide [SANCELER (registered trademark) TS made by Shanxian Chemical Industry Co., Ltd.]

(Rubber Roller)

The prepared rubber composition was supplied to an extrusion molding machine, was extrusion-molded in a cylindrical shape with an outer diameter of ϕ15 mm and an inner diameter of ϕ4.5 mm, and then was cut with a predetermined length, and the resultant was mounted in a temporary shaft for crosslinking with an outer diameter of ϕ3.5 mm.

Subsequently, by pressurizing and heating the cylindrical product in a vulcanizer using pressurized steam for 120° C.×10 minutes and then for 160° C.×20 minutes, the cylindrical product was foamed using gas generated by decomposition of the foaming agent and the rubber was crosslinked.

Then, the cylindrical product was mounted again in the shaft 4 with an outer diameter of ϕ6 mm having a conductive thermosetting adhesive applied to the outer circumferential surface thereof, the resultant was heated in an oven for 160° C.×60 minutes to carry out second crosslinking and to cure the thermosetting adhesive, whereby the cylindrical product was electrically connected to the shaft 4 and was mechanically fixed thereto.

Then, both ends of the cylindrical product were shaped, and the cylindrical product was finished with an outer diameter of ϕ13 mm (with tolerance of ±0.1 mm) to form a roller body 2 by performing traverse grinding on the outer circumferential surface 5 thereof using a cylindrical grinding machine, whereby a rubber roller 1 was manufactured.

<Example 6>

In the same way as in Example 5 except that the same amount of activated carbon [KURARAY COAL (registered trademark) PK-D made by KURARAY Co., Ltd.] was mixed instead of the zeolite, a rubber composition was prepared and a rubber roller 1 was manufactured.

<Example 7>

In the same way as in Example 5 except that the same amount of diatomite [TOPCO (registered trademark) No. 54 made by Showa Chemical Industry Co., Ltd.] was mixed instead of the zeolite, a rubber composition was prepared and a rubber roller 1 was manufactured.

<Comparative Example 5>

In the same way as in Example 5 except that zeolite was not mixed, a rubber composition was prepared and a rubber roller 1 was manufactured.

<Example 8, Comparative Example 6>

In the same way as in Example 5 except that the mixing proportion of zeolite was set to 35.0 parts by mass (Example 8) and 40.0 parts by mass (Comparative Example 6) with respect to total 100 parts by mass of rubbers, a rubber composition was prepared and a rubber roller 1 was manufactured.

<Example 9, Comparative Example 7>

In the same way as in Example 6 except that the mixing proportion of activated carbon was set to 20.0 parts by mass (Example 9) and 25.0 parts by mass (Comparative Example 7) with respect to total 100 parts by mass of rubbers, a rubber composition was prepared and a rubber roller 1 was manufactured.

<Example 10, Comparative Example 8>

In the same way as in Example 7 except that the mixing proportion of diatomite was set to 35.0 parts by mass (Example 10) and 40.0 parts by mass (Comparative Example 8) with respect to total 100 parts by mass of rubbers, a rubber composition was prepared and a rubber roller 1 was manufactured.

The above-mentioned evaluations were performed on the rubber rollers 1 which were manufactured in the examples and the comparative examples. The results are described in Tables 5 and 6.

TABLE 5

| | | Com. | | | |
|---|---|---|---|---|---|
| | | Ex. 5 | Example 5 | Example 6 | Example 7 |
| Parts by | NBR | 10 | 10 | 10 | 10 |
| mass | SBR | 10 | 10 | 10 | 10 |
| | BR | 10 | 10 | 10 | 10 |
| | EPDM | 10 | 10 | 10 | 10 |
| | GECO | 60 | 60 | 60 | 60 |
| | Zeolite | — | 15.0 | — | — |
| | Activated carbon | — | — | 15.0 | — |
| | Diatomite | — | — | — | 15.0 |
| Evaluation | Cell diameter | X | ◯ | ◯ | ◯ |
| | Contamination | X | ◯ | ◯ | ◯ |
| | Asker C hardness | ◯ | ◯ | ◯ | ◯ |
| | Roller resistance | ◯ | ◯ | ◯ | ◯ |
| | value | | | | |

TABLE 6

| | | Example | Example | Example | Com. | Com. | Com. |
|---|---|---|---|---|---|---|---|
| | | 8 | 9 | 10 | Ex. 6 | Ex. 7 | Ex. 8 |
| Parts by | NBR | 10 | 10 | 10 | 10 | 10 | 10 |
| mass | SBR | 10 | 10 | 10 | 10 | 10 | 10 |
| | BR | 10 | 10 | 10 | 10 | 10 | 10 |
| | EPDM | 10 | 10 | 10 | 10 | 10 | 10 |
| | GECO | 60 | 60 | 60 | 60 | 60 | 60 |
| | Zeolite | 35.0 | — | — | 40.0 | — | — |
| | Activated carbon | — | 20.0 | — | — | 25.0 | — |
| | Diatomite | — | — | 35.0 | — | — | 40.0 |
| Evaluation | Cell diameter | ◯ | ◯ | ◯ | ◯ | ◯ | ◯ |
| | Contamination | ◯ | ◯ | ◯ | ◯ | ◯ | ◯ |
| | Asker C hardness | ◯ | ◯ | ◯ | X | X | X |
| | Roller resistance | ◯ | ◯ | ◯ | ◯ | X | ◯ |
| | value | | | | | | |

From the results of Examples 5 to 10 and Comparative Example 5 in Tables 5 and 6, it can be understood that since foaming of the rubber composition can be relaxed, the average cell diameter of foamed cells can be decreased or the unevenness in cell diameter can be decreased, components serving as the source of contamination can be adsorbed, and a member or a sheet can be prevented from being contaminated due to transfer of the components by forming a roller body using the rubber composition in which at least one type of fine porous particles selected from the group consisting of zeolite, activated carbon, and diatomite are mixed, a rubber roller that can form an image with good image quality is obtained when the rubber roller is used as a transfer roller or the like.

From the results of Examples 5 and 8 and Comparative Example 6, it can be understood that in a system using zeolite as fine porous particles, the mixing proportion of the zeolite needs to be set to be equal to or less than 35 parts by mass with respect to total 100 parts by mass of rubbers in order to set the rubber hardness or the roller resistance value of the roller body to be in a range suitable for a transfer roller while maintaining the above-mentioned effects.

From the results of Examples 6 and 9 and Comparative Example 7, it can be understood that in a system using activated carbon as fine porous particles, the mixing proportion of the activated carbon needs to be set to be equal to or less than 20 parts by mass with respect to total 100 parts by mass of rubbers in order to set the rubber hardness or the roller resistance value of the roller body to be in a range suitable for a transfer roller while maintaining the above-mentioned effects.

From the results of Examples 7 and 10 and Comparative Example 8, it can be understood that in a system using diatomite as fine porous particles, the mixing proportion of the diatomite needs to be set to be equal to or less than 35 parts by mass with respect to total 100 parts by mass of rubbers in order to set the rubber hardness or the roller resistance value of the roller body to be in a range suitable for a transfer roller while maintaining the above-mentioned effects.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A rubber composition that is used to form a porous body for an image forming device using electrophotography, the rubber composition comprising:
a rubber that contains at least one type selected from a group consisting of diene-based rubbers and ethylene propylene-based rubbers, and an ion-conductive rubber;
a crosslinking component that crosslinks the rubber;
a foaming component that foams the rubber; and
fine porous particles of at least one type selected from a group consisting of zeolite, activated carbon, and diatomite,
wherein a total mixing proportion P of the fine porous particles of the three types with respect to a total proportion 100 parts by mass of the rubber satisfies Expression (1):
P≤Z×35+C×20+D×35 (1)
[where Z denotes a mass ratio of zeolite, C denotes a mass ratio of activated carbon, and D denotes a mass ratio of diatomite, when a total amount of the three types of fine porous particles is defined as 1].

2. The rubber composition according to claim 1, wherein the rubber contains only at least one type selected from the group consisting of diene-based rubbers and ethylene propylene-based rubbers, and the ion-conductive rubber.

3. A rubber roller comprising a porous roller body that is formed of the rubber composition according to claim 1.

4. A rubber roller comprising a porous roller body that is formed of the rubber composition according to claim 2.

5. An image forming device comprising the rubber roller according to claim 3.

6. An image forming device comprising the rubber roller according to claim 4.
